(19) United States
(12) Patent Application Publication
(10) Pub. No.: US 2009/0045646 A1
(43) Pub. Date: Feb. 19, 2009

(54) HINGE FOR STORAGE SYSTEM

(76) Inventors: Scott E. Clare, Danville, CA (US); Neil G. Long, Hayward, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/838,825

(22) Filed: Aug. 14, 2007

(51) Int. Cl. E05D 7/00; B60R 5/00

(52) U.S. Cl. 296/37.6; 16/233; 296/183.1

(57) ABSTRACT

A hinge system that can be installed within a storage compartment causes an initial downward displacement of a leading edge of a door panel when the door panel is initially opened outwardly. This enables the leading edge to slide under and around an overlapping upper door lip of the storage compartment. A seal may be provided in the overlapping portion of the door panel to assist with weatherproofing. A further seal compression position may be provided in which the door panel is rotated inwardly from the closed position to compress the seal.

### BACKGROUND OF THE INVENTION

The present invention relates to hinges for storage compartments, particularly hidden storage compartments for vehicles, such as pickup trucks.

Pickup trucks, vans and sport utility vehicles have long been a means for transporting and storing tools and other cargo. Conventional tool boxes on pickup trucks generally extend across the pickup cargo bed and, in so doing, remove available cargo space from the pickup bed. U.S. Pat. No. 6,105,231 to Clare et al., the disclosure of which is incorporated by reference, discloses a tool box storage compartment built into the side walls of a pickup cargo bed. By using the side wall compartment for storage, the storage system disclosed in U.S. Pat. No. 6,105,231 preserves pick up bed storage space and discourages theft by keeping stored tools from view.

The present invention provides improved hinges for storage compartments and, in the context of the built-in storage compartment described in U.S. Pat. No. 6,105,231, enhances the ability of the built-in storage compartment to provide a weatherproof seal.

### BRIEF SUMMARY OF THE INVENTION

The present invention provides for a hinge system that can be installed within the interior of a storage space to enable movement of a door panel from a closed position to an open position. The hinge system enables an initial downward displacement of a leading edge of the door panel when the door panel is initially opened outward. This enables the leading edge to slide under and around an overlapping upper door lip of the storage compartment. A seal may be provided in the overlapping portion of the door panel and the upper door lip that provides a weatherproof seal when the door panel is closed. A further seal compression position may be provided in which the door panel is rotated inwardly from the closed position to compress the seal. It should be understood that the present invention is applicable to storage lockers, cabinets, overhead storage compartments, and other such storage compartments and security enclosures.

One embodiment is directed to a hinge system that includes first and second pivot arms, first and second traveling arms, and a panel interface arm. The first pivot arm has a free end and a fixed end rotatably attached to a base plate at a first pivot point, a second pivot arm having a free end and a fixed end rotatably attached to the base plate at a second pivot point. The first pivot point is disposed inward of the second pivot point. The first traveling arm has an inner end rotatably coupled to the free end of the first pivot arm and an outer end rotatably coupled to an upper portion of the panel interface arm. The first traveling arm is further rotatably coupled to an intermediate portion of the second pivot arm. The second traveling arm has an inner end rotatably coupled to the free end of the second pivot arm and an outer end rotatably coupled to a lower portion of the panel interface arm.

One application is directed to a vehicle bed having a hidden storage area located entirely therein that includes an upper door lip, a door panel, and a hinge system disposed within the interior of the storage area configured to enable reciprocal movement of the door panel from a closed position to an open position. The hinge system includes a panel interface arm coupled to the door panel and hinge components rotatably fixed to the interior of the storage area and rotatably coupled to the panel interface arm. The hinge system is configured to enable a downward displacement of the door panel when the door panel is initially opened outwardly from the closed position such that a leading edge of the door panel moves under and around the upper door lip when the door panel is opened.

One embodiment of the present invention is directed to a hinge system that includes a panel interface arm configured for coupling with a door panel and hinge components rotatably fixed to a base plate and rotatably coupled to the panel interface arm. The hinge components cooperate to enable a downward displacement of the panel interface arm when the panel interface arm is initially opened outwardly from the closed position.

Further aspects and advantages of the present invention are set forth below in the detailed description of the preferred embodiments.

### BRIEF DESCRIPTION OF THE DRAWINGS

FIG. 1 illustrates a vehicle bed having a hidden storage compartment.

FIG. 2 illustrates a hidden vehicle bed storage compartment utilizing the improved hinge system in accordance with an embodiment of the present invention.

FIG. 3 shows an embodiment of the hinge system in accordance with the present invention in a closed position.

FIG. 3A is a view from direction 3A of FIG. 3 showing the planes on which the hinge components are disposed.

FIG. 4 shows the hinge system of FIG. 2 in a first intermediate position.

FIG. 5 shows the hinge system of FIG. 2 in a second intermediate position.

FIG. 6 shows the hinge system of FIG. 2 in an open position.

FIG. 7 is a detail of the inner pivot arm showing the notch for receiving the fixed end of the outer pivot arm in the open position.

FIGS. 8A and 8B are details showing how the notch of the upper traveling arm receives the pivot between the lower traveling arm and the outer pivot arm.

FIG. 9 shows an improved storage compartment door design in accordance with the present invention and the travel of the leading edge of the door panel with respect thereto.

FIG. 10 shows the hinge system of FIG. 2 in a seal compression position.

FIG. 11 shows how the seal compression position of FIG. 10 improves the weatherproof design shown in FIG. 9.

### DETAILED DESCRIPTION OF THE INVENTION

Embodiments of the present invention provide systems and methods for enabling reciprocal movement of a storage compartment door panel from a closed position to an open position. A hinge system is provided that enables an initial downward displacement of a leading edge of the door panel when the door panel is initially opened outward. This enables the leading edge to slide under and around an overlapping upper door lip of the storage compartment. A seal may be provided in the overlapping portion of the door panel and the upper door lip that provides a weatherproof seal when the door panel is closed. A further seal compression position may be provided in which the door panel is rotated inwardly from the closed position to compress the seal.

The present design improves the weatherproofing seal and reinforces the door and frame by encouraging contiguous contact along the door/frame mating edge of the storage compartment, which is especially important in a hidden truck bed storage compartment due to a long door edge and frame rigidity issues. U.S. Pat. No. 6,105,231 to Clare et al., the entirety of which is incorporated herein by reference, provides a hidden storage system that can be incorporated in the bed of a vehicle without altering the bed's external appearance or the width of the vehicle bed. The storage system is located adjacent the wheel well sections of the bed and uses hinges to open and close the side panel of the bed. Since the storage system does not alter the truck's external appearance, it reduces the attraction for theft. Also, since the storage area does not extend inwardly beyond the conventional wheel wells, the storage system leaves most of the truck bed free for use. The present application provides an improved hinge system of particularly advantageous application to the hidden storage compartments of U.S. Pat. No. 6,105,231. It should be understood that the improved hinge system of the present invention may also be applied to other storage compartments or enclosures.

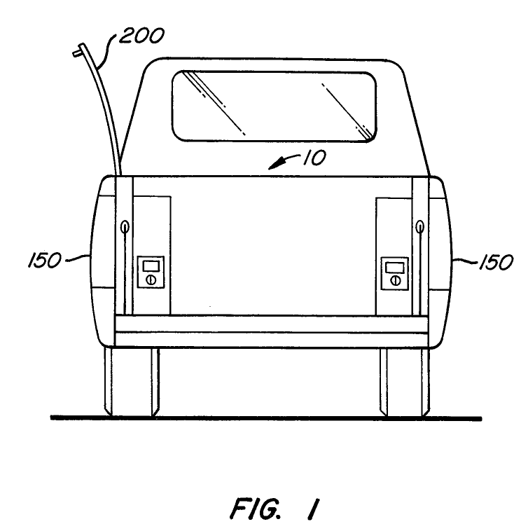

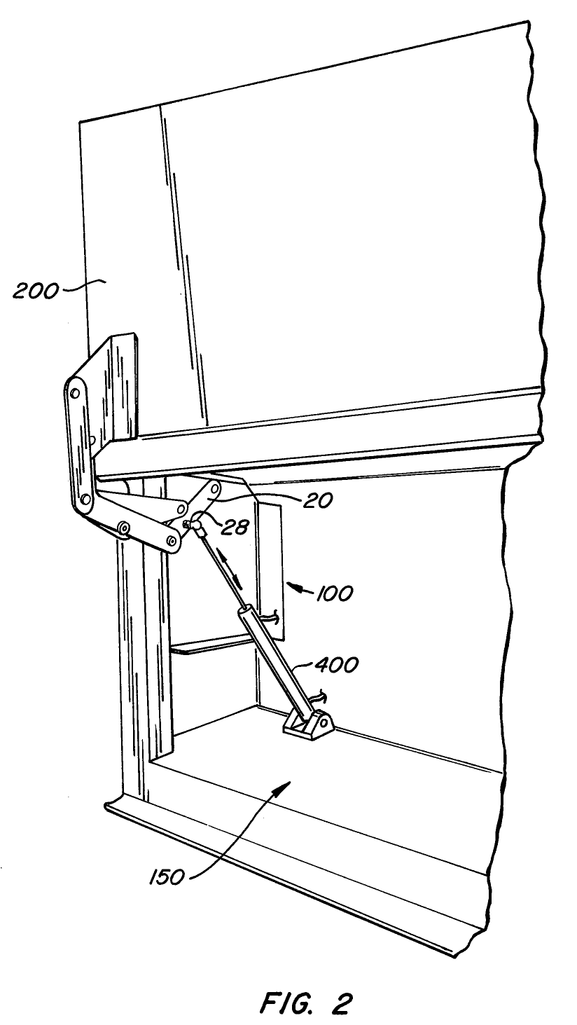

FIG. 1 shows a vehicle bed having a hidden storage compartment of the type shown in U.S. Pat. No. 6,105,231. In particular, FIG. 1 shows a vehicle bed 10 that includes storage compartments 150 hidden entirely within either flank of the vehicle bed. Each storage compartment 150 includes a door panel 200, shown in the open position in FIG. 1. FIG. 2 shows the hidden vehicle bed storage system utilizing the hinge design of the present invention. As shown in FIG. 2, hinge 100 is attached to an interior of the hidden storage compartment 150. Door panel 200 is coupled to hinge 100. An assist mechanism 400 may be provided to help actuate the opening of the door panel 200, as will be described in more detail below.

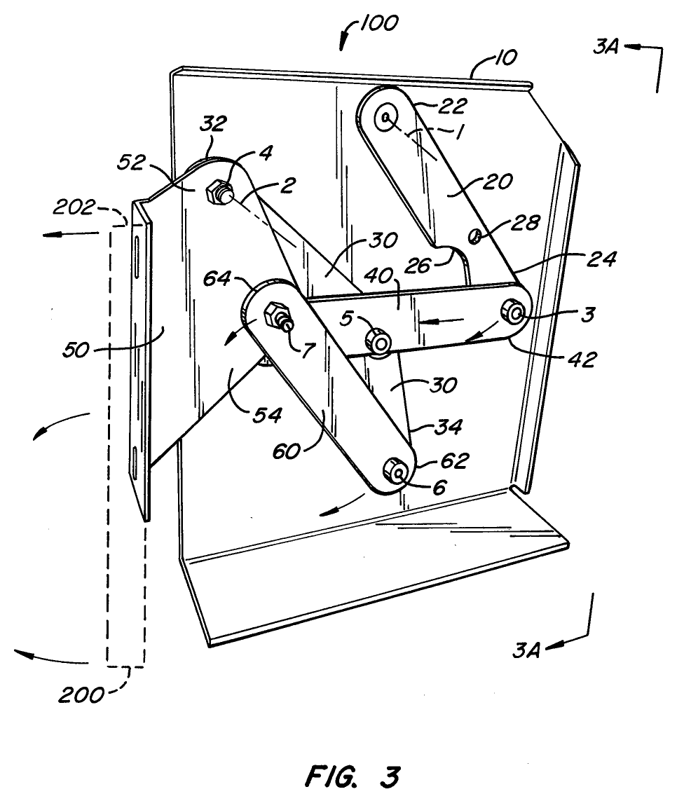

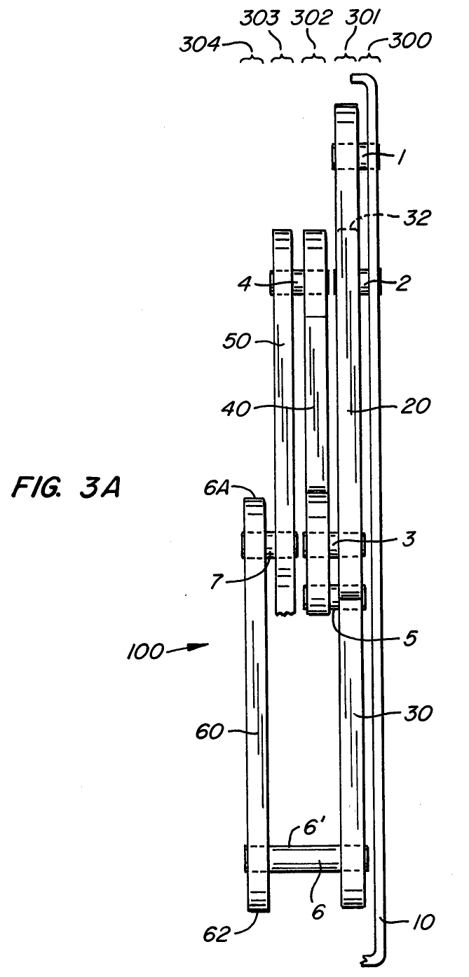

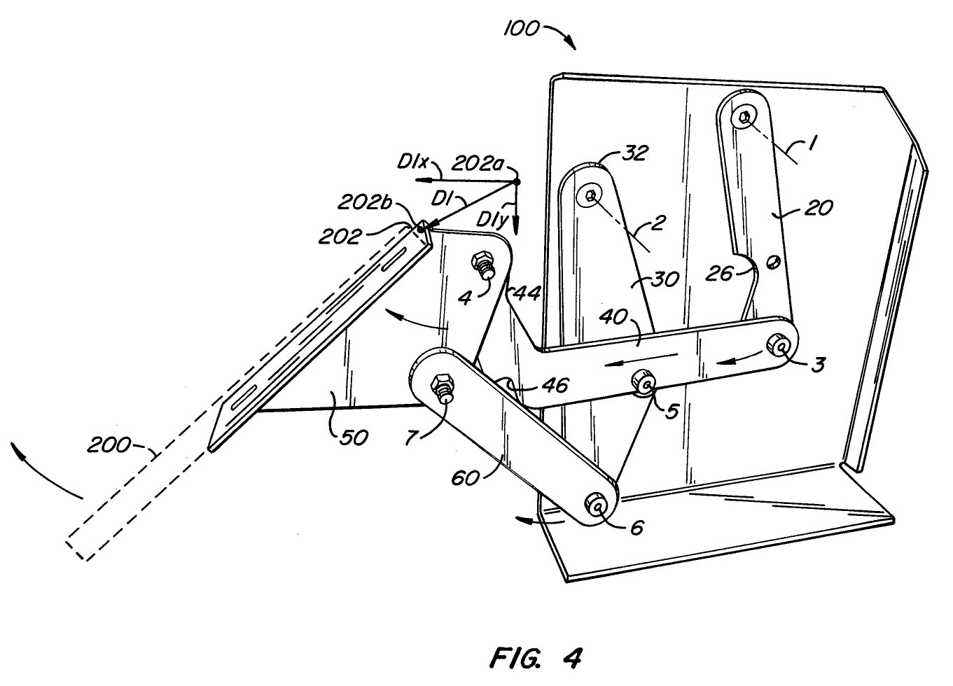

FIG. 3 shows an embodiment of the hinge 100 in accordance with the present invention. As shown in FIG. 3, hinge 100 is in a position where the door panel 200 (shown in dashed lines) is in the closed position. Hinge 100 is attached to a back plate 10 to which the components of the hinge are secured. Plate 10 may be an interior panel of the storage compartment or may be a separate plate that enables hinge 100 to be modularly installed into the storage compartment. A fixed end 22 of inner pivot arm 20 is rotatably fixed to plate 10 at pivot point 1. As used herein, “rotatably fixed” means that the fixed end 22 cannot move relative to pivot point 1, but that pivot arm 20 is capable of rotating about pivot point 1. A fixed end 32 of outer pivot arm 30 is rotatably attached to plate 10 at pivot point 2 (obscured in FIG. 3, see FIG. 4). Inner pivot arm 20 and outer pivot arm 30 are both disposed in a first plane immediately adjacent and above plate 10 (see, FIG. 3A).

As used herein, “inner”, “inward”, and “inwardly” refer to a direction pointing toward an interior of the storage compartment (i.e., to the right in FIG. 3). “Outer”, “outward”, and “outwardly” refer to a direction pointing outside of the storage compartment and to the direction the door panel 200 is configured to open (i.e., to the left in FIG. 3). “Up”, “upward”, and “upwardly” refer to a direction pointing toward the position of pivot points 1 and 2 and the top of the page in FIG. 3. “Down”, “downward”, and “downwardly” refer to a direction pointing away from pivot points 1 and 2 and toward the bottom of the page in FIG. 3. “Above” and “below” are used to refer to planes disposed further out of the page in FIG. 3 and into the page in FIG. 3, respectively.

From the perspective of FIG. 3, upper traveling arm 40 is disposed in a second plane immediately above the first plane in which pivot arms 20 and 30 are disposed. Upper traveling arm 40 is attached at three locations. An inner end 42 of arm 40 is rotatably coupled to a free end 24 of inner pivot arm 20 at pivot point 3. As used herein, “rotatably coupled” means that arm 40 and arm 20 are coupled together and capable of rotating with respect to each other about pivot point 3. An outer end 44 (obscured in FIG. 3, see FIG. 4) of upper traveling arm 40 is rotatably coupled to an upper end 52 of panel interface arm 50 at pivot point 4. Panel interface arm 50 is disposed in a third plane immediately above the second plane in which traveling arm 40 is disposed. An intermediate portion of traveling arm 40 is also rotatably attached to an intermediate portion of outer pivot arm 30 at pivot point 5. Traveling arm 40 is not directly attached to plate 10 and is free to travel with pivot arms 20 and 30 when the hinge is in motion.

Lower traveling arm 60 is rotatably attached at a lower end 62 to the free end 34 of the outer pivot arm 30 at pivot point 6. An upper end 64 of the lower traveling arm 60 is rotatably attached to a lower portion 54 of panel interface arm 50 at pivot point 7. The upper end 64 of lower traveling arm 60 is disposed in a fourth plane immediately above the third plane in which the panel interface arm 50 is disposed. The lower end of arm 60 may be disposed in the fourth plane, for example, by placing a spacer between outer pivot arm 30 and lower traveling arm 60 at pivot point 6. Lower end 62 of arm 60 may also be disposed in a plane in between the second and fourth planes, as will be explained in further detail below.

FIG. 3A is an elevation view of hinge 100 from direction 3A of FIG. 3. FIG. 3A illustrates the relative position of the hinge components in the first, second, third, and fourth planes, as discussed above. With reference to the figure, inner pivot arm 20 and outer pivot arm 30 both lie in the first plane 301 immediately adjacent and above (left in FIG. 3A) plane 300 of plate 10. Upper traveling arm 40 lies in the second plane 302 immediately adjacent and above plane 301. Panel interface arm 50 lies in the third plane 303 immediately adjacent and above plane 302. Upper end 64 of lower traveling arm 60 lies in the fourth plane 304 immediately adjacent and above plane 303. Lower end 62 of arm 60 may lie in the fourth plane 304 or in a plane between the third plane 303 and the fourth plane 304 through use of a spacer 6′ disposed between outer pivot arm 30 and lower traveling arm 60 at pivot point 6. The thickness of spacer 6′ should be selected so as to enable lower traveling arm 60 to clear panel interface arm 50 when the hinge is in operation.

FIG. 4 shows hinge 100 in a first intermediate position in which panel 200 has been swung open by approximately 45 degrees from the closed position. This initial movement of panel 200 may be accomplished by a force on panel 200 in the outwardly direction that causes a torque about pivot point 7. In a preferred embodiment, this initial force requires no downward component. The initial displacement of panel 200 causes its leading edge 202 to move in a direction that is both downwardly and outwardly (as shown in FIG. 4, the leading edge of the panel 200 is in substantially the same position as the leading edge of panel interface arm 50). In particular, the initial position of leading edge 202 is represented as 202a and its first intermediate position is represented as 202b. The travel between 202a and 202b is shown as displacement D1, which has a downward component D1y and an outward component D1x. The downward component D1y in the initial displacement of leading edge 202 is important because it prevents interference with weatherproofing seal material located between leading edge 202 and an upper door portion (not shown) against which the leading edge abuts in a fully closed position. The hinge design also enables the panel door 200 to be opened using only an outwardly force, but produces a displacement in the downward direction. As will be discussed in detail below, this feature enables designs for the panel door that are more weatherproof and that allows the panel door to be opened clear of a sealing lip in the door frame. As shown in FIG. 4, free pivot points 3-7 also experience displacements when panel 200 is opened to its first intermediate position.

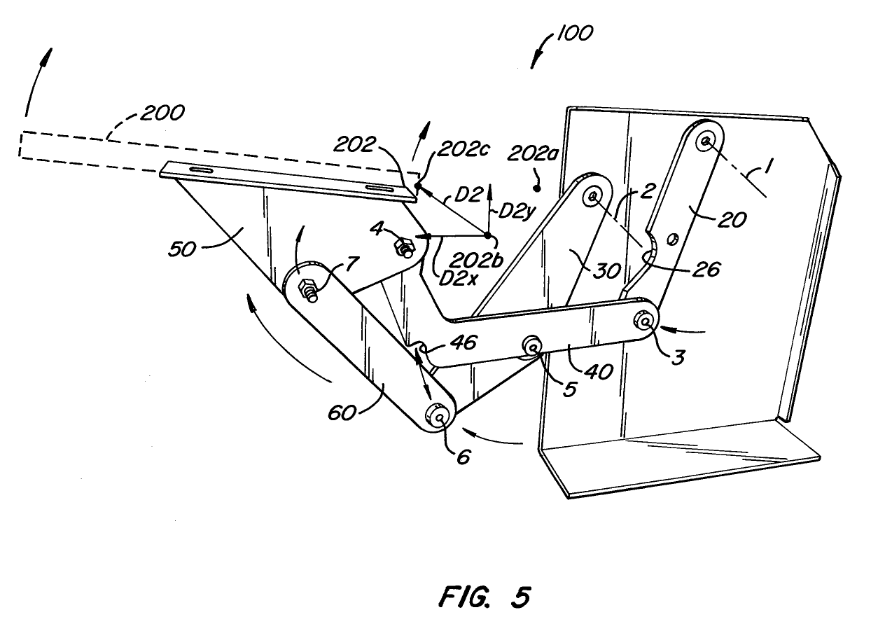

FIG. 5 shows hinge 100 in a second intermediate position in which panel 200 has been swung open by approximately 90 degrees. This second movement of panel 200 may be accomplished by a force on panel 200 of FIG. 4 in the outward and upward direction. The continued rotation of inner pivot arm 20 and outer pivot arm 30 enable the upper and lower traveling arms 40 and 60 to further displace outwardly. Accordingly, this enables the panel 200 to further displace outwardly. As shown in FIG. 5, in this second intermediate position, lower traveling arm 60 may have traveled entirely outside of the interior of the storage compartment. The outward displacement of the hinge components enable leading edge 202 of panel 200 to experience a second displacement D2 from its prior position 202b to its position 202c in the second intermediate position. D2 has an outward component D2x and an upward component D2y, which substantially cancels the previous downward displacement D1y. Therefore, the leading edge 202 displaces by an aggregate amount of D1x and D2x during the travel of the panel 200 from the closed position (FIG. 3) to the second intermediate position in which the panel 200 has rotated outwardly by approximately 90 degrees (FIG. 5). This sequence of movements enables leading edge 202 to be swung downwardly and outwardly (D1) and then upwardly and outwardly (D2) around an upper lip of the door frame.

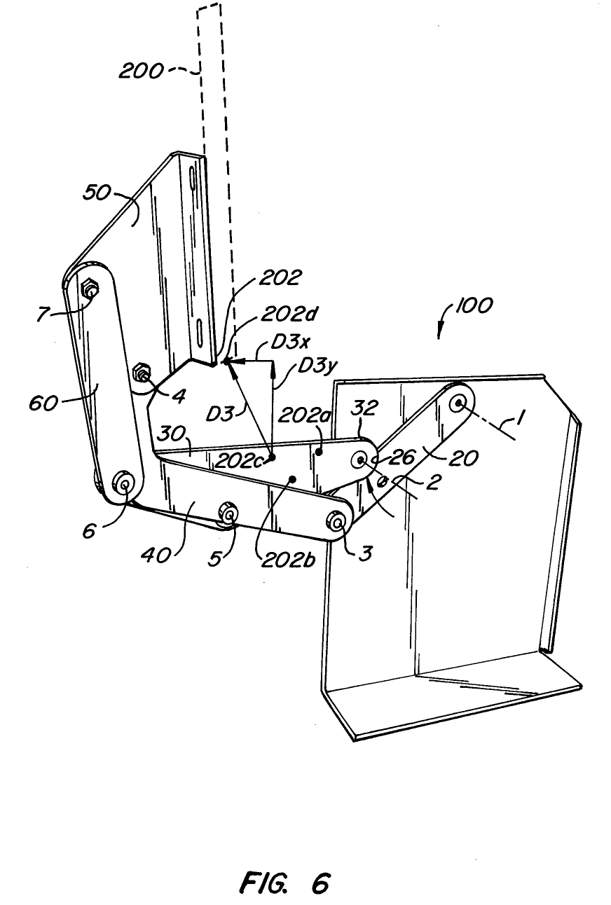

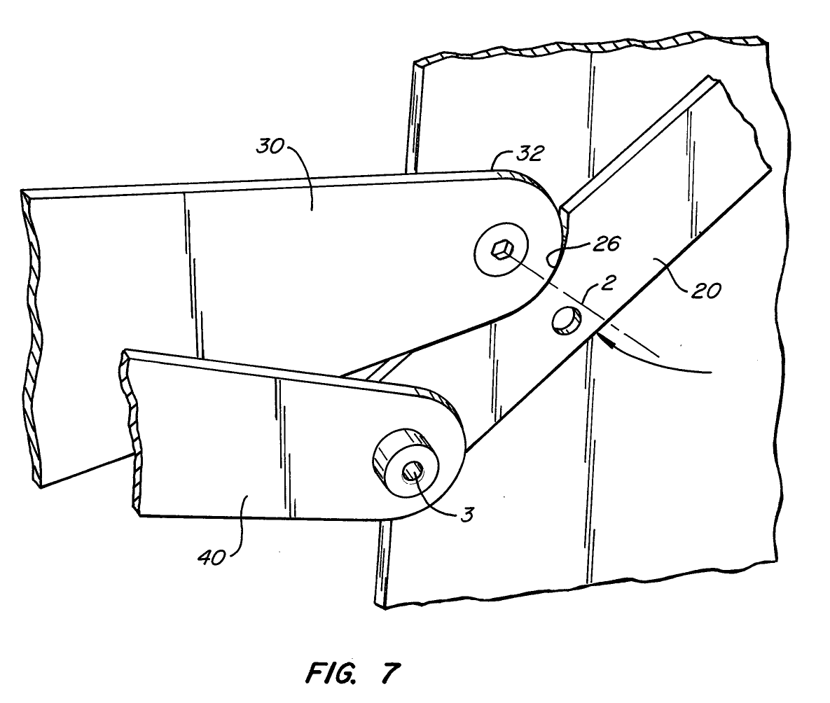

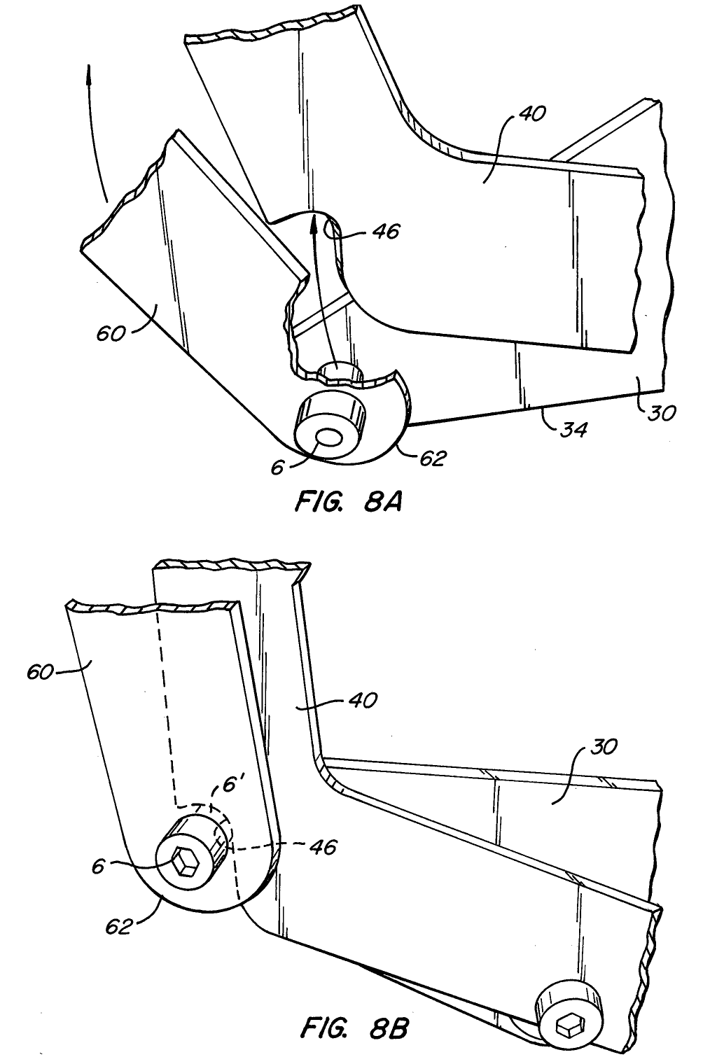

FIG. 6 shows a final, open state of the hinge 100 in which the panel 200 has been swung open by approximately 180 degrees. As shown in FIG. 6, inner pivot arm 20 has been rotated to the end of its travel such that its notch 26 (shown in FIG. 5) abuts against fixed end 32 of outer pivot arm 30. As detailed in FIG. 7, notch 26 is shaped so as to fit the outline of fixed end 32 in its final position. Notch 26 enables an additional measure of rotation by both inner pivot arm 20 and outer pivot arm 30 so as allow panel 200 to be opened by approximately 180 degrees. Notch 26 further serves to provide a secure stop for the final, open position of pivot arms 20 and 30. Similarly, in the upper traveling arm notch 46 (shown in FIG. 5) comes to abut against pivot point 6 in the space between lower traveling arm 60 and outer pivot arm 30. As detailed in FIGS. 8A and 8B, pivot point 6 swings upwardly and slightly outwardly immediately prior to reaching its final position to contact upper traveling arm notch 46, which rests against spacer 6′ in the open position. Upper traveling arm notch 46 cooperates with inner pivot arm notch 26 to enable an additional measure of rotation by outer pivot arm 30 and provides a secure stop for the final position of pivot point 6 (which links lower traveling arm 60 and outer pivot arm 30) and upper traveling arm 40.

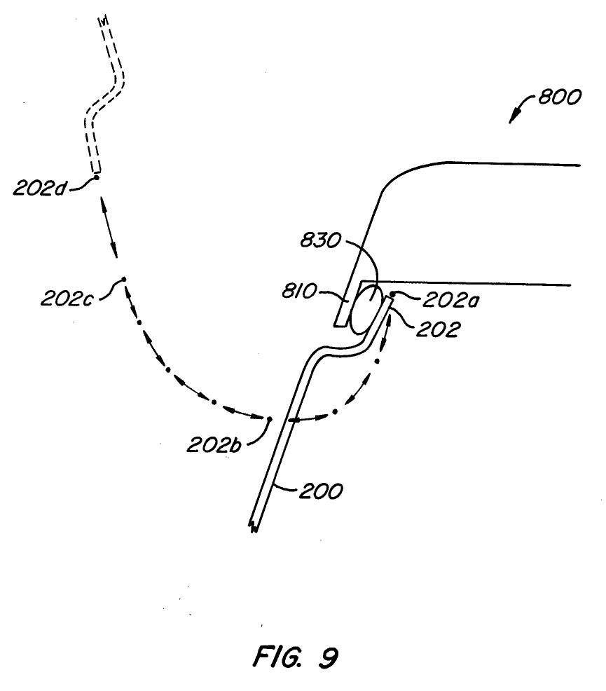

Referring back to FIG. 6, leading edge 202 of panel 200 experiences a displacement D3 from point 202c to 202d when panel 200 is swung open from the second intermediate position to the open position. Displacement D3 has a component D3x in the outward direction and a component D3y in the upward direction. Therefore, from the closed position to the open position, leading edge 202 experiences the aggregate outward displacement of D1x, D2x, and D3x. As D1y and D2y substantially cancel each other, the aggregate upward displacement of leading edge 202 is approximately D3y. FIG. 9 is a diagram that shows how the travel of the leading edge 202 contributes to an improved design for a weatherproof storage compartment.

In particular, FIG. 9 illustrates the path of the leading edge 202 of panel door 200 from its initial, closed state to its final, open state with relation to storage compartment top 800. In particular, the storage compartment top 800 has an storage compartment top lip 810 under which leading edge 202 should fit when panel 200 is fully closed. As shown in FIG. 9, leading edge 202 moves through a series of positions from 202a to 202d as the panel 200 is swung open. The unique movement of hinge 100 enables leading edge 202 to avoid the lip 810 when it is opened by moving downardly and outwardly, and thereby enables panel 200 to be slid under and around the overlapping lip 810. When the panel 200 is closed, leading edge 202 slides underneath lip 810 to enable an overlapping fit that improves the weatherproofing qualities of the compartment, especially when used with seals 830, which, in this design, can be provided without interfering with the opening movement of panel 200.

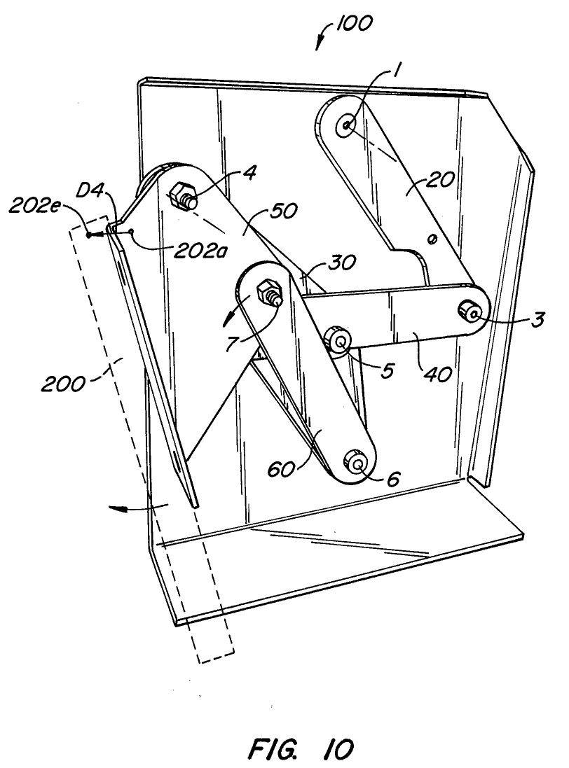

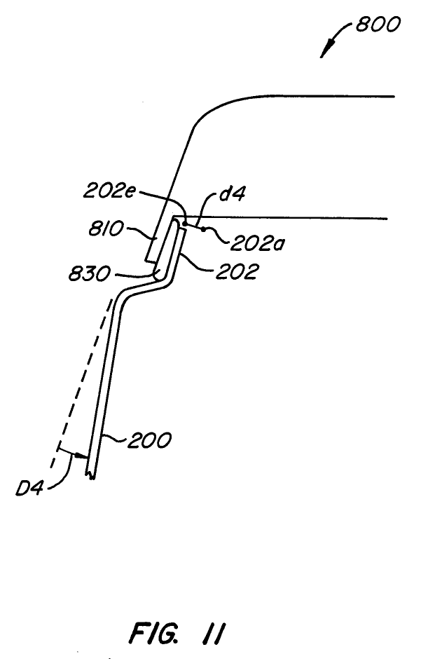

FIG. 10 shows another feature of hinge 100 that enables improved weatherproofing capabilities, especially when used with a compressible seal 830, such as that shown in FIG. 9. In a seal compression position, panel interface arm 50 (and panel 200 coupled to the interface) rotates inwardly about pivot point 4 from the closed position (shown in FIG. 3). This inward rotation causes leading edge 202 to displace by D4 (mostly an outwardly displacement) from closed position 202a to a seal compression position 202e. As shown in FIG. 11, in addition to the displacement of the leading edge 202, door panel 200 is caused to rotate inwardly by an angular displacement of D4 from its position in FIG. 9. This movement compresses seal 830 between the overlapping portion of door panel 200 and lip 810 to improve the weatherproofing qualities of seal 830.

Returning to FIG. 2, assist mechanism 400 may be a hydraulic arm secured within the storage compartment. Arm 400 may be attached to inner pivot arm 20 at attachment point 28 (shown in FIG. 3). Arm 400 may be used to provide most or all of the force used to move hinge 100 from the closed position to the open position. For example, arm 400 may take over after a small initial force in the outwardly direction on the panel 200, or may entirely operate the hinge after panel 200 is unlatched. Hydraulic arm 400 may provide the force to rotate inner pivot arm 20 from its initial position (the closed position or the seal compression position) all the way to its open position where notch 26 abut against fixed end 32 of the outer pivot arm 30. Other equivalent assist mechanism may also be used, such as a spring system, to power the rotation of inner pivot arm 20 about pivot point 1.

Further aspects of the invention provide that the hinge may be adjusted or installed to allow a neutral operating zone when the door panel is closed so that there is little or no resistive forces on the door panel. Hinge component linkages and fixed pivot positions can be modified to accommodate different door height opening clearances and/or door frame clearances. The hinge may be increased or decreased in size to accommodate different doors and may be built of metal, composite materials, a combination thereof, or any other suitable materials known to one of ordinary skill in the art. The hinge may be used on vehicles, trucks, electrical enclosures, aircraft, boats, storages, high security enclosures, bio-hazard enclosures, etc., and wherever it is desired that a watertight door opening be provided with a hinge mechanism securely disposed within the compartment.

It should be understood that while the above embodiments were discussed in one spatial orientation, the principles of the present invention are applicable regardless of the orientation of the door panel and the compartment. For example, the hinge system may be used in a door panel that swings open about a bottom hinge to lift the leading edge over a lip of the bottom door frame or sideways over a plumb or vertical lip on the enclosure frame.

The foregoing describes some embodiments that implement the concepts of the present invention. The description is for purposes of illustration and not limitation. Modifications of the above embodiments that are within the ordinary skill of the art are fully contemplated and encompassed by the scope of the present invention, which is limited only by the appended claims.

What is claimed is:

1. A hinge system configured to enable reciprocal movement of a panel interface arm from an inward closed position to an outward open position, the system comprising:
a base plate;
a first pivot arm having a free end and a fixed end rotatably attached to said base plate at a first pivot point;
a second pivot arm having a free end and a fixed end rotatably attached to said base plate at a second pivot point;
a first traveling arm having an end rotatably coupled to the free end of the first pivot arm and another end rotatably coupled to a panel interface arm, wherein the first traveling arm is further rotatably coupled to an intermediate portion of the second pivot arm; and
a second traveling arm having an end rotatably coupled to said free end of said second pivot arm and an end rotatably coupled to said panel interface arm.

2. The system of claim 1, wherein the first and second pivot arms are both disposed in the same plane.

3. The system of claim 2, wherein the first traveling arm is disposed in a plane different from the plane with the first and second pivot arms.

4. The system of claim 3, wherein the panel interface arm is disposed in a plane different from the planes with the first traveling arm, first pivot arm and second pivot arm.

5. The system of claim 1, wherein the hinge system enables a downward displacement of the panel interface arm when the panel interface arm is initially opened outwardly from the closed position.

6. The system of claim 5, wherein the panel interface arm is attached to a storage compartment door.

7. The system of claim 5, wherein the panel interface arm is configured to rotate inwardly from the closed position to provide a seal compression position.

8. The system of claim 1, wherein the panel interface arm is configured to move from the closed position to a first intermediate position at which the panel interface arm is rotated outwardly by about 45 degrees and a leading edge of the panel interface arm is displaced both outwardly and downwardly from the closed position.

9. The system of claim 8, wherein the panel interface arm is configured to move from the first intermediate position to a second intermediate position at which the panel interface arm is further rotated outwardly by about 45 degrees and the leading edge is further displaced both outwardly and upwardly from the first intermediate position.

10. The system of claim 1, wherein the panel interface arm is configured to move from the closed position to the open position at which the panel interface arm is rotated outwardly by about 180 degrees and a leading edge of the panel interface arm is displaced both outwardly and upwardly from the closed position.

11. The system of claim 1, further comprising a secure stop for the open position of the system.

12. The system of claim 11, wherein a notch in the first pivot arm helps provide said secure stop.

13. The system of claim 11, wherein a notch in the first traveling arm helps provide a secure stop.

14. The system of claim 1, further comprising an assist mechanism configured to bias the system toward the open position.

15. The system of claim 1, wherein the panel interface arm is configured to move from the closed position to the open position such that a leading edge of the panel interface arm follows a substantially U-shaped path as the panel interface arm rotates outwardly by about 180 degrees.

16. The system of claim 1, wherein said free end of said second pivot arm is disposed lower than said free end of said first pivot arm in the closed state of the system.

17. The system of claim 1, wherein said second pivot point is disposed lower than said first pivot point.

18. A vehicle bed having a hidden storage area located entirely therein comprising an upper door lip, a door panel, and a hinge system disposed within an interior of the storage area configured to enable reciprocal movement of the door panel from a closed position to an open position, such that when said door panel is pulled outwardly, it initially moves downwardly.

19. A vehicle bed having a hidden storage area located entirely therein comprising an upper door lip, a door panel, and a hinge system disposed within an interior of said storage area configured to enable reciprocal movement of the door panel from a closed position to an open position, the hinge system comprising a panel interface arm coupled to the door panel and hinge components rotatably fixed to the interior of the storage area and rotatably coupled to a panel interface arm, wherein the hinge system is configured to enable a downward displacement of the door panel when the door panel is initially opened outwardly from the closed position such that a leading edge of the door panel moves under and around the upper door lip when the door panel is opened.

20. The vehicle bed of claim 19, wherein hinge components are rotatably fixed at one or more pivot points, and wherein the downward displacement of the door panel moves the door panel away from the pivot points.

21. The vehicle bed of claim 19, wherein the door panel is configured to rotate inwardly from the closed position to a seal compression position to compress a seal disposed between the upper door lip and the door panel.

22. The vehicle bed of claim 19, wherein the door panel is configured to move from the closed position to the open position at which the door panel is rotated outwardly by about 180 degrees and the leading edge of the door panel is displaced both outwardly and upwardly from the closed position.

23. The vehicle bed of claim 19, further comprising a secure stop for the open position of the door panel.

24. The vehicle bed of claim 19, further comprising an assist mechanism configured to bias the door panel toward the open position.

25. The system of claim 19, wherein the door panel is configured to move from the closed position to the open position such that the leading edge follows a substantially U-shaped path as the panel interface arm rotates outwardly by about 180 degrees.

26. A hinge system configured to enable reciprocal movement of a door panel from a closed position to an open position, the system comprising:
a panel interface arm configured for coupling with a door panel;
hinge components rotatably fixed to a base plate and rotatably coupled to said panel interface arm, wherein said hinge components cooperate to enable a downward displacement of the panel interface arm when the panel interface arm is initially opened outwardly from a closed position.

27. The system of claim 26, wherein hinge components are rotatably fixed to said base plate at one or more pivot points, and wherein the downward displacement of the panel interface arm moves the panel interface arm away from the pivot points.

28. The system of claim 26, wherein the panel interface arm is configured to rotate inwardly from said closed position to provide a seal compression position.

29. The system of claim 26, wherein the hinge components provide a secure stop for the open position of the system.

30. The system of claim 26, wherein the panel interface arm is configured to move from the closed position to the open position such that a leading edge of the panel interface arm follows a substantially U-shaped travel as the panel interface arm rotates outwardly by about 180 degrees.
